(19) United States
(12) Patent Application Publication
(10) Pub. No.: US 2020/0311252 A1
(43) Pub. Date: Oct. 1, 2020

(54) System and Method for Cleaning/Wiping and Transferring Digital Data of Various Devices, Digital Assets and Account Information Upon Death of a Customer or Member

(71) Applicant: Christopher W. Huziak, Youngstown, OH (US)

(72) Inventor: Christopher W. Huziak, Youngstown, OH (US)

(21) Appl. No.: 16/826,591

(22) Filed: Mar. 23, 2020

Related U.S. Application Data
(60) Provisional application No. 62/824,607, filed on Mar. 27, 2019.

(51) Int. Cl. G06F 21/46; G06Q 50/18; G06Q 50/26; G06Q 10/10; G06Q 50/00; G06F 9/54; H04L 29/06

(52) U.S. Cl. CPC G06F 21/46; G06Q 50/186; G06Q 50/265; H04L 63/10; G06Q 50/01; G06F 9/547; G06Q 10/107

(57) ABSTRACT

A system and method for cleaning/wiping and transferring digital data of various devices, digital assets, account information and social media accounts upon death of a customer or member, wherein the customer self-registers and selects their desired number of devices and other levels of service, where once registered in the system as a member, an artificial intelligence (AI) process is run daily to determine whether the member is living, i.e., verify their status, such that when a vital check process identifies someone (i.e., the member) as deceased, automated and manual verification steps are triggered, and if a confirmation that the customer is deceased is received, then registered and active (payment current) services are executed, otherwise if a confirmation that the customer is deceased is not received, then the customer becomes marked as a false positive for a predetermined number of days.

### CROSS-REFERENCE TO RELATED APPLICATION(S)

This application claims priority from U.S. Provisional Application Ser. No. 62/824,607 filed Mar. 27, 2019, the content of which is incorporated herein by reference in its entirety.

### BACKGROUND OF THE INVENTION

### 1. Field of the Invention

The present invention relates to identity protection and, more particularly, to a system and method for cleaning/wiping and transferring digital data of various devices, digital assets and account information upon death of a customer or member.

### 2. Description of the Related Art

As explained by Sid Kirchheimer in a recent 2019 article entitled “Protecting the Dead From Identity Theft”, identity thieves are sinking to new lows—specifically, six feet under. As explained by Kirchheimer, each year these identity thieves use the identities of nearly 2.5 million deceased Americans to fraudulently open credit card accounts, apply for loans and obtain cellphone or other services, according to fraud prevention firm ID Analytics.

Nearly 800,000 of those deceased people are deliberately targeted, e.g., roughly 2,200 a day. The identities of the others are used by chance. Here, criminals create a Social Security number that just happens to match that of someone who has died.

This practice is called “ghosting”, and because it can take up to six months or even longer for financial institutions, credit-reporting bureaus and the Social Security Administration to receive, share or register death records, crooks have ample time to accumulate charges. It will be appreciated the dead do not monitor their credit, for obvious reasons. Moreover, the grieving survivors of the deceased often fail to monitor the assumed inactive credit.

Sometimes, criminals glean personal information from hospitals or funeral homes. More often, the crime begins with thieves trolling through obituaries. With a name, address and birth date in hand, these unscrupulous individuals can illicitly purchase the person's Social Security number on the Internet for as little as $10.

At certain times of the year, criminals may file tax returns under the identities of deceased individuals, collecting refunds (e.g., a total of $5.2 billion in 2011) from the Internal Revenue Service (IRS).

The only good news here is that surviving family members are ultimately not responsible for such charges (or for legitimate debts of the dead if their names are not on the accounts). But ghosting can still cause plenty of angst.

### SUMMARY OF THE INVENTION

Disclosed is a system and method for cleaning/wiping and transferring digital data of various devices, digital assets and account information upon death of a customer or member. In accordance with the invention, a customer self-registers and selects their desired number of devices and other levels of service. In alternative embodiments, the customer is registered by a third party entity, such as an insurance company.

Once registered in the system as a member, an artificial intelligence (AI) processes is run daily to determine whether the member is living, i.e., their status. If the vital check process identifies someone (i.e., the member) as deceased, then automated and manual verification steps are triggered.

On the one hand, if a confirmation that the customer is deceased is received, then registered and active (payment current) services are executed. On the other hand, if a confirmation that the customer is deceased is not received, then the customer becomes marked as a false positive for a predetermined number of days.

The disclosed system and method solve a number of problems. For example, the system and method provide protection against ghosting and other forms of cybercrime, provide protection for all forms of assets and provide “peace-of-mind” for the customer (i.e., member) in knowing their data has been “wiped” or erased. This can include hiding information that the member may not want to become known, thereby protecting any intellectual property that may be on their systems such that unwanted parties can be protected and prevented from profiting from any abandoned work that the deceased may have owned while alive. Moreover, the system and method provide protection against identity theft, and provide protection against masquerade attacks, where others do not know this person is deceased. A masquerade attack is any attack that uses a forged identity (such as a network identity) to gain unofficial access to a personal or organizational computer.

Problems are additionally solved by the disclosed system and method by removing social media accounts such that these types of accounts do not exist in perpetuity. Here, as before, in this way the system and method protect against access to any information a customer may not want to be known. Moreover, the system and method provide a member with security of their information from social related attacks and information gathering that could be used against them, or their family and/or friends.

The disclosed system and method additionally provide the ability to transfer digital information, and thus provide another layer of protection by providing an information vault. The information vault provides a way to ensure services that do not need to be deleted will be transferred to an appropriate entity or person. The information vault also provides a method to ensure the member's intended digital assets are transferred to the intended beneficiary, such as individual or collections of files, documents, photos and other digital assets. As a result, problems associated with working with companies when seeking to prove and/or establish ownership and gain access to the accounts of the deceased member become eliminated.

An initial customer onboarding process is the initial step pursuant to the performing the method in accordance with the invention. Here, a customer creates an account at a website. The account creation process begins with entering the following exemplary information, i.e., personal information, customer contact information, customer contact/beneficiary contact information.

Next, the customer selects services, such as the number of devices to protect based on a monthly fee per device, paid annually, the number of social services to protect for a one-time fee per level, information vault information transfer service (monthly fee per device, paid annually), and credit card information. Upon successful processing, the customer will enter the portal to begin entering information for their selected services.

With respect to the devices that will be covered, the customer adds their devices (e.g., desktop computers, laptops, tablets or mobile phones) into the system. For each device that is added, the system sends that device to a mobile device management (MDM) service. This integration creates the link between the device and system, and allows for the remote wipe and other services.

The MDM software sends the customer an email with instructions to link and register their device(s) with the system for management in accordance with the method of the invention. It should be noted that this is an important step and, is clear in a term of service (TOS), that the onus of this step and responsibility is on the customer, or services cannot be rendered. The portal at which customers interface with the services shows with red and green indicators if this link is visible to the system, i.e., whether services can be executed when needed. In accordance with the invention, notifications are sent to the customer or member when the registered devices are not sensed with a designated period of time. This designated period of time is adjustable, depending on the age and well-being of the customer or member. Accordingly, the time period can extend from a period of weeks to months.

For any relevant social media/service accounts, the customer adds their social/service account(s), such as Facebook, Twitter or LinkedIn. Here, the customer supplies information such as the service name, a username, a password and notes. It should be understood that the mentioned services, Facebook, Twitter or LinkedIn, are exemplary and it is not the intention to be limited to these platforms. That is, the system and method of the invention are applicable to any social media/service account.

With respect to information transfer, the information vault establishes a collection of usernames and passwords for internet services, files, documents, photos and other digital assets which, upon confirmation of death, will be transferred to their registered contact/beneficiary. Here, the customer supplies, a service name, a username, a password and notes. As for files or collections of files and other digital assets, the customer adds a label/name for each entry, notes and supplies the files or collections of files and other digital assets for storage.

The method and system include an inventive process that continually checks to determine the status of the customer or member, i.e., are they alive or deceased. In accordance with the invention, the process is initiated and runs daily at a predetermined time, such as midnight or 1200 hrs. The process utilizes code that uses automated web searches, via an application program interface (API), automations through search engines. Here, the searches utilize the contact information of the member in combination with other word phrases to retrieve or pull search results. These results are passed through an algorithm to determine whether the customer is indeed no longer alive.

In accordance with the invention, a short message service (SMS) confirmation is provided. When the above-described check process identifies a customer or member, the system generates an automatic text message requesting the customer reply with “alive” within a predetermined time window, such as a 12-hour window. If the customer or member responds, then the customer or member is marked as a false positive. If the customer fails to respond, then the customer is placed into a queue to be contacted directly, e.g., manually via telephone. As such, it should be appreciated the “contact/beneficiary” aspect of the invention is a manual step in the process, where the member is directly contacted via telephone to confirm their status when no SMS confirmation is obtained.

Pursuant to the manual aspects of the invention, the beneficiary of the member is contacted, where the contact/beneficiary provided by the member is contacted directly via telephone to confirm the status of the member when no SMS and no phone confirmation were obtained.

Upon the occurrence of the following, e.g., no SMS confirmation is received from the member, no phone confirmation is received from the member and a confirmation from the contact/beneficiary that the customer or member is deceased is received, “services” provided in accordance with the system and method of the invention are executed. The service includes cleaning/wiping any registered devices via the MDM software, and a manual log-in to the registered social/cloud services belonging to the customer or member is performed to delete the accounts. In addition, the information vault is transferred to the contact/beneficiary who will receive an email notification instructing them on how to access a special portal where this information will be available. When all services have been successfully executed, a report is generated and emailed to both the customer email as well as the contact/beneficiary via email.

Within the scope of the invention, the terms “digital footprint”, “digital estate”, “digital estate planning” and “end of life services” are all associated with cleaning/wiping and transferring digital data of various devices and account information.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

An exemplary embodiment of the invention is explained in greater detail below with reference to the drawings, this comprising schematic and greatly simplified figures in, which:

FIG. 1 is a flowchart of the system for performing cleaning/wiping data of a deceased member; and

FIG. 2 flowchart of the method associated with performing cleaning/wiping data of a deceased member.

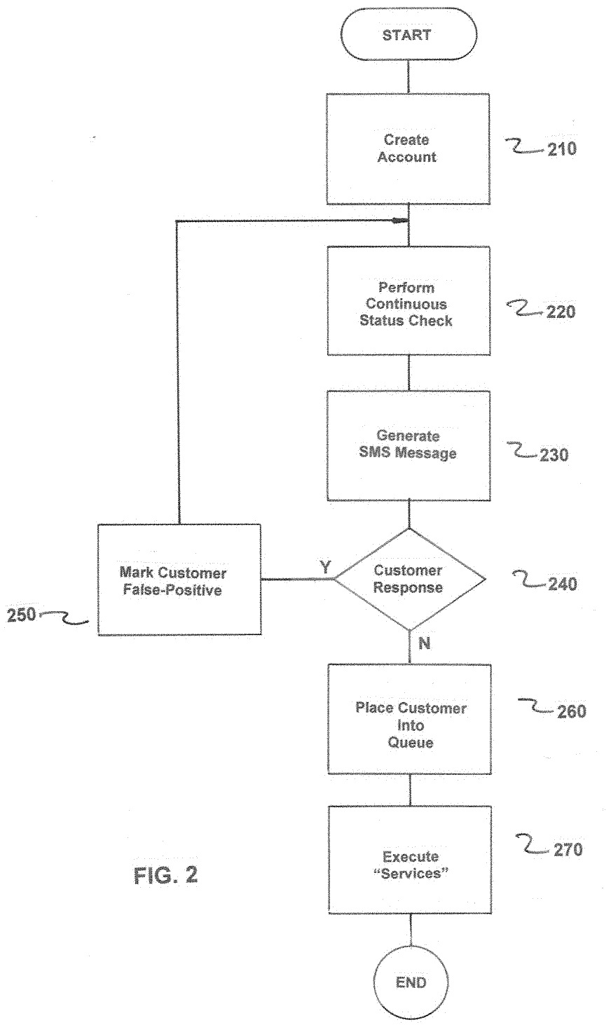

### DETAILED DESCRIPTION OF THE EXEMPLARY EMBODIMENTS

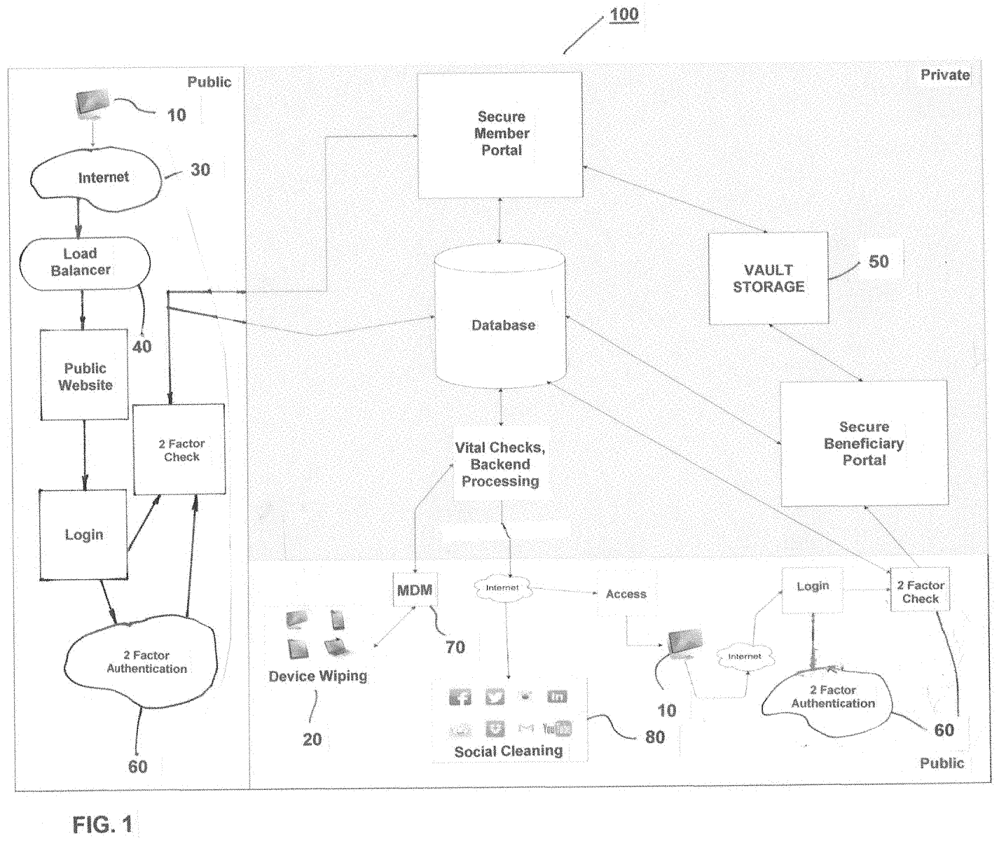

FIG. 1 is a schematic block diagram of the system architecture 100 for eliminating a “digital foot print” or “digital estate” of a member, in manner that provides “end-of-life services” such that “digital death” is ensured. With reference to FIG. 1, the system includes a computer 10 through which a customer self-registers and selects their desired number of devices 20 and other levels of service, such as “social cleaning” to ensure a “social death”, i.e., delete all social media accounts, allow data assembled over a lifetime to die, be expunged or deleted.

A load balancer 30 is used to distribute a set of tasks over a set of resources (e.g., computing units) such that the overall processing associated with self-registration of the customer is more efficient. In this way, the response time for each task is optimized, which avoids unevenly overloading compute nodes while other compute nodes are left idle.

The system implements a public website 40 that provides potential customers with information and instructions for registering with the system. Once registered in the system as a member, an artificial intelligence (AI) processes is run daily to determine whether the member is living, i.e., their status. If this check process identifies someone (i.e., the member) as deceased, automated and manual verification steps are triggered.

Thus, if a confirmation that the customer is deceased is received, then registered and active (payment current) services will be executed. Otherwise, the customer becomes marked as a false positive for a predetermined number of days.

Vault server 50 stores a member's digital information. Here, usernames and passwords to any service are stored in a manner which also permit the storage of files, notes associated with each entry, or other digital assets. Digital Photos are also stored at the vault server 50, i.e., a single, memorable photo or a collection that the member wishes to pass on or bequeath.

Also stored in the vault server 50 are sensitive documents, such as a will, or a collection of information that beneficiaries will need. The vault server 90 creates an efficient, organized and centrally located information vault for the beneficiary of a member to find all important information after the life of the member has ended. A member has continual access to the vault server 50 to permit the member to add digital copies of information such as financial final documents, and to add passwords, family photos, and other digital assets.

The disclosed system 100 and method thus additionally provide the ability to transfer digital information, and thus provide another layer of protection by providing data from the information vault. The information vault provides a way to ensure services that do not need to be deleted will be transferred to an appropriate entity or person. The information vault also provides a method to ensure the member's intended digital assets are transferred to the intended beneficiary, such as individual or collections of: files, documents, photos and other digital assets. As a result, problems associated with working with companies when seeking to prove and/or establish ownership and gain access to the accounts of the deceased member become eliminated.

An initial customer onboarding process is the initial step pursuant to performing the method in accordance with the invention. Here, a customer creates an account at the public website 40. The account creation process begins by entering the following exemplary information, e.g., personal information, customer contact information, customer contact/beneficiary contact information, where a login is facilitated by the login web server 30 in a conventional manner. Two factor authentication 60 is implemented to provide secure customer/member verification. Two-factor authentication (also known as 2FA) is a type, or subset, of multi-factor authentication. Two-factor authentication 60 provides a way to confirm the claimed identity of a customer/member by using a combination of two different factors: i) something they know, ii) something they have, or iii) something they are.

Next, the customer selects services, such as the number of devices to protect based on a monthly fee per device, the number of social services to protect for a one-time fee per level, information vault transfer service (e.g., monthly fee per device, paid annually), and credit card information. Upon successful processing, the customer enters the portal to begin entering information for their selected services.

With respect to the devices 20 that will be covered, the customer adds their devices (e.g., desktop computers, laptops, tablets or mobile phones) into the system. For each device that is added, the system sends that device to a mobile device management (MDM) service 70. This integration creates the link between the device and system, and allows for a remote “wipe” of the digital device and other services.

MDM software of the MDM service 70 sends the customer an email with instructions to link and register their device(s) with the system 100 for management in accordance with the method of the invention. It should be noted that this is an important step and, is clear in the terms of service (TOS), that the onus of this step and responsibility is on the customer, or services cannot be rendered. The portal at which customers interface with the services shows with red and green indicators if this link is visible to the system, i.e., whether services can be executed when needed. In accordance with the invention, notifications are sent to the customer or member when the registered devices are not sensed within a designated period of time. This designated period of time is adjustable, depending on the age and well-being of the customer or member. Accordingly, the time period can extend from a period of weeks to months.

For the social media/service accounts 80, the customer adds their social/service account(s), such as Facebook, Twitter or LinkedIn. Here, the customer supplies information such as the service name, a username, a password and notes.

With respect to information transfer, the information vault created by the vault server 50 establishes a collection of usernames and passwords for internet services, files, documents, photos and other digital assets which, upon confirmation of death, will be transferred to their registered contact/beneficiary. Here, the customer supplies, a service name, a username, a password and any notes for services. As for files or collections of files and other digital assets, the customer adds a label/name for each entry, notes and supplies the files or collections of files and other digital assets for storage.

The method and system includes an inventive process that continually checks to determine the status of the customer or member, i.e., are they alive or deceased. In accordance with the invention, the process is initiated and runs daily at a predetermined time, such as midnight or 1200 hrs. The process utilizes code that uses automated web searches, via API automations, through search engines. Here, the searches utilize the contact information of the member in combination with other word phrases to retrieve search results. These results are then passed through an algorithm to determine where the customer is indeed no longer alive.

In accordance with the invention, an SMS confirmation is utilized to provide notifications to customers or members. When the above-described check process identifies a customer or member, the system generates an automatic SMS message requesting the customer reply with “alive” within a fixed time window. Preferable, the fixed window is a 12-hour window. If the customer or member responds, then the customer or member is marked as a false positive. If the customer fails to respond, then the customer is placed into a “queue” to be contacted directly, manually via telephone. As such, it should be appreciated the “contact member” aspect of the invention is a manual step in the process where the member is directly contacted via phone to confirm their status when no SMS confirmation was obtained.

Pursuant to the manual aspects of the invention, the beneficiary of the member is contacted, where the contact/beneficiary provided by the member is contacted directly via phone to confirm the status of the member when no SMS and no phone confirmation were obtained.

Upon the occurrence of the following, the “services” provided in accordance with the system and method of the invention will be executed, e.g., no SMS confirmation is received from the member, no phone confirmation is received from the member and confirmation from the contact/beneficiary that the customer or member is deceased. The services include cleaning/wiping any registered devices VIA the MDM software, a manual log-in into the registered social/cloud services belonging to the customer or member is performed to delete the accounts. In addition, the information vault is transferred to the contact/beneficiary who will receive an email notification instructing them on how to access a special portal where this information will be available. When all services have been successfully executed a report is generated and emailed to both the customer as well as the contact/beneficiary.

Problems are additionally solved by the disclosed system and method by removing social media accounts such that these types of accounts do not live in perpetuity. Here, as before, in this way the system and method protects against any information customer my not want to be known from being accessed. Moreover, the system and method provides information security from social related attacks and info gathering that could be used against them, or their family and/or friends.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those method steps which perform substantially the same function in substantially the same way to achieve the same results are within the scope of the invention. Moreover, it should be recognized that method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for cleaning/wiping and transferring digital data of a plurality of devices, digital assets and account information upon death of a customer or member from a system, the method comprising:
creating a customer account at a public website;
performing a continuous automated web Internet searches, via application program interface (API) automations, through search engines to determine the status of the customer;
transmitting a message to the customer requesting the customer to transmit a reply within a predetermined time window;
performing a check to determine a response from the customer;
returning to said step of performing the continuous automated web searches when the status from the customer indicates the customer is alive;
placing the customer into a queue when the customer fails to respond; and
initiating services to clean/wipe and transfer digital data of the plurality of devices, digital assets and account information.

2. The method as claimed in claim 1, wherein the customer enters information comprising at least personal information, customer contact information, customer contact information and beneficiary contact information.

3. The method as claimed in claim 1, wherein two factor authentication is implemented to provide secure customer verification.

4. The method as claimed in claim 1, wherein creating the customer account at the public comprises selecting services; wherein the services comprise at least one of a number of devices to protect, a number of social services to protect, information vault transfer service and credit card information.

5. The method as claimed in claim 4, wherein each device is added to a mobile device management (MDM) service to create a link between each device and the system.

6. The method as claimed in claim 5, wherein MDM software of the MDM service sends an email to the customer including instructions to link and register devices with the MDM service for management.

7. The method as claimed in claim 1, wherein creating the customer account at the public comprises adding at least one of social media and cloud service accounts to the customer account via a member portal.

8. The method as claimed in claim 1, wherein a collection of usernames and passwords for internet services which are transferred to a contact/beneficiary registered by the customer are stored in a vault server.

9. The method as claimed in claim 1, wherein said continuous automated web searches are initiated and run at a predetermined time.

10. The method as claimed in claim 9, wherein the predetermined time is midnight or 1200 hrs.

11. The method as claimed in claim 1, wherein contact information of the customer is utilized in combination with other phrases to retrieve search results during the continuous automated web searches over the internet.

12. The method as claimed in claim 1, wherein a time-period for response from the customer is a 12-hour time window.

13. The method as claimed in claim 1, further comprising:
marking the customer as a false positive when the status from the customer indicates the customer is alive;

14. The method as claimed in claim 6, wherein said services comprises (i) cleaning/wiping any registered devices VIA the MDM software, (ii) manually logging into registered social/cloud services belonging to the customer to delete accounts, (iii) transferring the information vault and (iv) generating and emailing a report to the contact/beneficiary.

16. A system for cleaning/wiping and transferring digital data of a plurality of devices, digital assets and account information upon death of a customer or member from a communication system, the system comprising:
a webserver hosting a public website for creating a customer account;
a webserver having a processor and memory, said webserver accessing a database for performing continuous automated Internet web searches, via API automations, through search engines to determine a status of the customer; and
a vault server which stores collection of digital assets \, usernames and passwords for internet services which are transferred to a contact/beneficiary registered by the customer;
wherein the system is configure to:
receive a customer account created at the public website;
transmit a message to the customer requesting the customer to transmit a reply within a predetermined time window;
perform a check to determine a response from the customer;
return to said performing the continuous automated web searches when the status from the customer indicates the customer is alive;
place the customer into a queue when the customer fails to respond; and
initiate services to clean/wipe and transfer digital data of the plurality of devices, digital assets and account information.

17. The system as claimed in claim 16, wherein the customer enters information comprising at least personal information, customer contact information, customer contact information and beneficiary contact information.

18. The system as claimed in claim 16, wherein two factor authentication is implemented to provide secure customer verification.

19. The system as claimed in claim 16, wherein creating the customer account at the public website comprises selecting services; and wherein the services comprise at least one of a number of devices to protect, a number of social services to protect, information vault transfer service and credit card information.

20. The system as claimed in claim 19, wherein said devices comprise at least one of desktop computers, laptops, tablets and mobile phones.

21. The system as claimed in claim 19, wherein each device is added to a mobile device management (MDM) service to create a link between each device and the communication system.

22. The system as claimed in claim 21, wherein MDM software of the MDM service sends the customer an email with instructions to link and register devices with the MDM service for management.

23. The system as claimed in claim 16, wherein creating the customer account at the public website comprises adding at least one of social media and service accounts to the MDM service.

24. The system as claimed in claim 16, wherein said continuous automated web searches are initiated and run at a predetermined time.

25. The system as claimed in claim 24, wherein the predetermined time is midnight or 1200 hrs.

26. The system as claimed in claim 16, wherein contact information of the customer is utilized in combination with other phrases to retrieve search results during the continuous automated Internet web searches.

27. The system as claimed in claim 16, wherein a time-period for response from the customer is a 12-hour time window.

28. The system as claimed in claim 22, wherein said services comprise (i) cleaning/wiping any registered devices via the MDM software, (ii) manually logging into registered social/cloud services belonging to the customer to delete accounts, (iii) transferring the information vault and (iv) generating and emailing a report to the contact/beneficiary.
